(19) United States
(12) Patent Application Publication
(10) Pub. No.: US 2025/0377020 A1
(43) Pub. Date: Dec. 11, 2025

(54) Modular magnetic axial bearing with removable winding

(71) Applicant: SKF Magnetic Mechatronics, Saint-Marcel (FR)

(72) Inventors: Eduardo CARRASCO, Saint Etienne (FR); Julien VAUBY, Rouen (FR); Nicolas POLO, Taverny (FR); David SEON, Vernon (FR)

(21) Appl. No.: 19/226,653

(22) Filed: Jun. 3, 2025

(30) Foreign Application Priority Data
Jun. 10, 2024 (FR) FR2406074

(51) Int. Cl. F16C 32/04

(52) U.S. Cl. CPC F16C 32/0476

(57) ABSTRACT

A modular magnetic axial bearing includes a base (2) extending along a longitudinal axis (XX′). The base has a blind cavity (26). The modular magnetic axial bearing includes an arrangement of coils and an annular overmoulded block (18). The arrangement of coils is embedded inside the annular overmoulded block. The annular overmoulded block is removably mounted in said blind cavity (26). The modular magnetic axial bearing includes a cover (3) removably mounted on the base (2) in such a manner as to enclose said overmoulded block (18) in said blind cavity (26).

### CROSS-REFERENCE TO RELATED APPLICATION

This application claims priority to French Application No. FR2406074, filed Jun. 10, 2024, the entirety of which is hereby incorporated by reference.

### FIELD

The present disclosure concerns magnetic axial bearings notably intended to be connected to an industrial machine.

The present disclosure aims to constitute a magnetic axial bearing that includes a removable winding that can be removed from the base non-destructively thanks to a new production method.

### BACKGROUND

In known methods for the production of a magnetic axial bearing the various components are placed in turn in a bearing support, namely an electrically insulative part, followed by a pre-wired arrangement of coils, before overmoulding the whole directly in said bearing support.

In the event of an electrical fault due inter alia to an insulation defect there is no possibility of repair or refurbishment, notably of the coil circuit, because of the encapsulation of the components during overmoulding, which implies that the overmoulding material, for example resin, is forced into the bearing support everywhere.

In the event of a need for repair or replacement, only the bearing support can generally be recovered, although damaged, all other components of the bearing being destroyed.

Moreover, during the production process the wire-cable connection is made either by a soldered splice or by a crimped sleeve.

In both cases this imposes preparation of the wire and cable before making and then insulating the connection.

All these manual operations are particularly time-consuming and open to improvement.

Finally, the openings in the bearing must be sealed to prevent the overmoulding material leaking, which requires dedicated tooling and an additional step before assembling other mechanical elements.

### SUMMARY

The present disclosure has for object alleviating at least some of the aforementioned drawbacks.

Given the foregoing, the present disclosure has for object a modular magnetic axial bearing including a base extending along a longitudinal axis and including a blind housing, an arrangement of coils and an annular overmoulded block inside which the arrangement of coils is embedded and which is removably mounted in said housing, said modular magnetic axial bearing further including a cover removably mounted on the base in such a manner as to enclose said overmoulded block in said housing.

This produces a modular magnetic axial bearing in which a previously wound and connected coil assembly is overmoulded in an overmoulding mould having a shape identical to the bearing support that will afterwards receive the overmoulded block of coils, the various components being removably stacked in said bearing support.

The modular magnetic axial bearing may further include an electrically insulative part embedded in the overmoulded block.

The bearing preferably further includes removable means for closure of the cover on the base and an elastic assembly mounted in compression between the cover and the base or the overmoulded block in such a manner as to push said cover along the longitudinal axis against said removable closure means.

For example, the elastic assembly includes a plurality of elastic elements disposed in a circle around the longitudinal axis.

The elastic elements advantageously include a material including elastomer or metal.

In one embodiment at least one of the elastic elements has a ball shape, a toroidal shape, an annular shape, a continuous elongate shape open or closed on itself, a spring shape or a corrugated blade shape.

In one embodiment the overmoulded block includes at least one radial protuberance and the base includes a hollow in which said protuberance is engaged in such a manner as to immobilise the arrangement of coils in rotation about the axis relative to said base.

The modular magnetic axial bearing advantageously further includes a connector plate electrically connected to and forming a projection relative to said arrangement of coils, the at least one connector plate being overmoulded in the overmoulded block and at least partially in the radial protuberance.

The connector plate may include one or more insulation displacement contacts.

The present disclosure also concerns a method of producing a modular magnetic axial bearing as described hereinabove in which the arrangement of coils is overmoulded in an overmoulding mould to form an overmoulded block integrating said arrangement of coils, said overmoulded block is placed in the housing of the base, and said overmoulded block is enclosed in the base by removably closing the base with the cover.

The overmoulding mould used in the method preferably includes a box forming a hollow in which the connector plate is engaged in such a manner as to block rotation about the axis of the arrangement of coils relative to said overmoulding mould when the arrangement of coils is overmoulded in the overmoulding mode.

### BRIEF DESCRIPTION OF THE DRAWINGS

The present disclosure will be better understood after detailed study of one embodiment as depicted by way of non-limiting example in the appended drawings, in which:

FIG. 1 represents a first embodiment of the modular magnetic axial bearing according to the present disclosure.

FIG. 2 represents the wired arrangement of coils that is included in the modular magnetic axial bearing.

FIG. 3 represents the overmoulding mould for forming the overmoulded block based on the wired arrangement of coils during the method of producing the modular magnetic axial bearing from FIG. 1, in open position.

FIG. 4 represents the FIG. 3 overmoulding mould, in closed position.

FIG. 5 represents the underside of the overmoulding cover depicted in FIG. 3.

FIG. 6 represents the overmoulded block produced by the step of overmoulding the arrangement of coils.

FIGS. 7 and 8 represent the base in which the overmoulded block is inserted for the production of the modular magnetic axial bearing.

FIGS. 9 and 10 represent the base in which the overmoulded block is inserted for the production of a modular magnetic axial bearing according to a second embodiment.

FIGS. 11 and 12 represent the base in which the overmoulded block is inserted for the production of a modular magnetic axial bearing according to a third embodiment.

### DETAILED DESCRIPTION

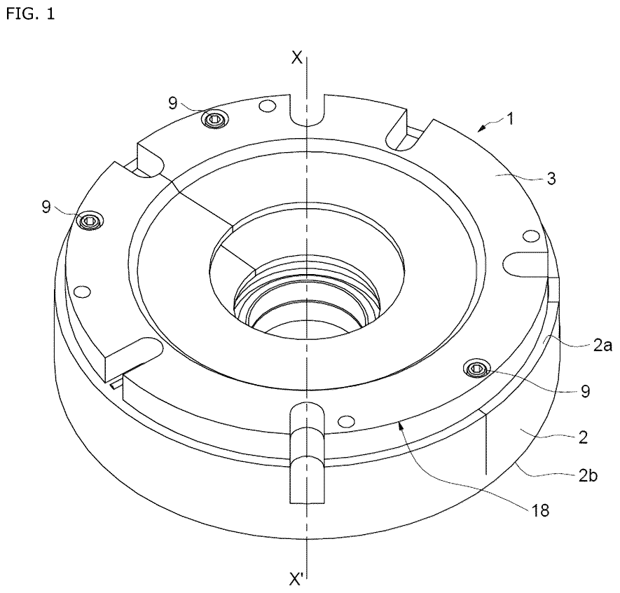

FIG. 1 depicts a first embodiment of a modular magnetic axial bearing 1 according to the present disclosure.

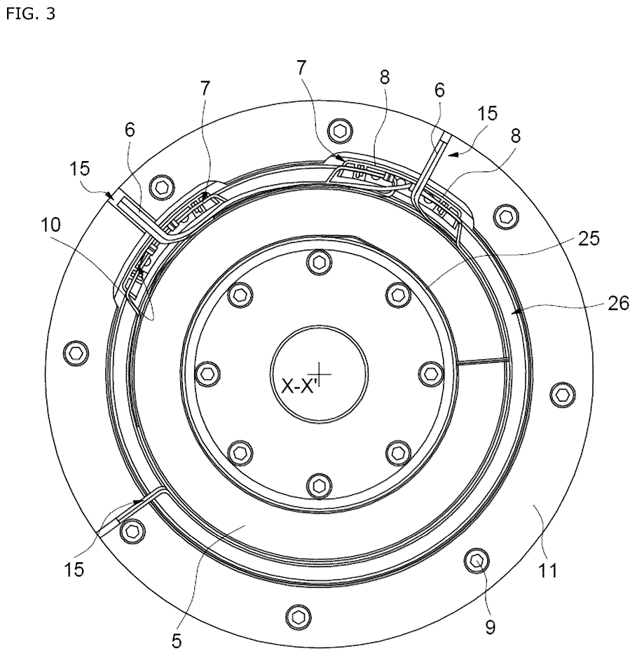

The modular magnetic axial bearing 1 includes a base 2 extending along a longitudinal axis XX′ and including a blind housing or cavity 26 (seen in FIGS. 3, 8, 10 and 12).

The base 2 has opposite first and second front faces 2a, 2b delimiting its thickness. The blind housing 26 extends axially from the first front face 2a. The bottom of the blind housing 26 remains at an axial distance from the first front face 2b.

The base 2 may be made of a magnetic material.

The modular magnetic axial bearing 1 includes an arrangement of coils 5 and an annular overmoulded block 18.

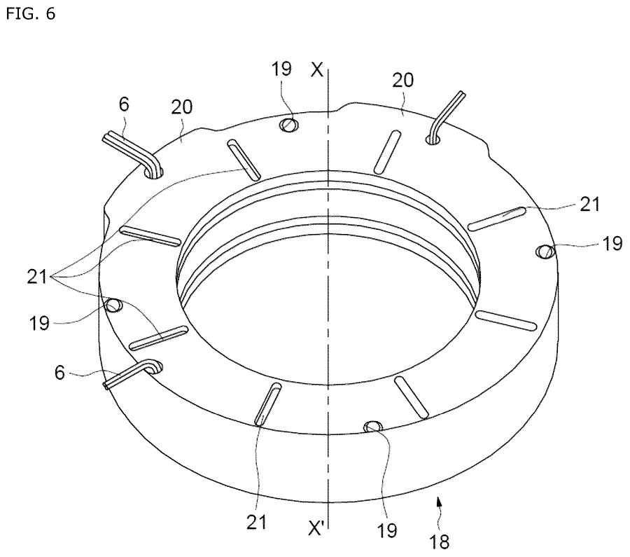

The arrangement of coils 5 is embedded in the overmoulded block 18, which is depicted in FIG. 6.

As depicted in FIG. 3, the arrangement of coils 5 is of annular shape and is configured to be integrated into an overmoulding mould 11 during the production of the modular magnetic axial bearing 1.

After overmoulding the arrangement of coils 5 a totally encapsulated and insulated block 18 is obtained that enables its components to be retained in position relative to one another so that they do not collide and can be electrically tested in advance.

The modular magnetic axial bearing 1 further includes a cover 3 removably mounted on the base 2 in such a manner as to enclose said overmoulded block 18 in the housing 26.

In the position with the cover 3 mounted on the base 2 the overmoulded block 18 is inaccessible from the outside.

The overmoulding mould 11 includes passages 15 through which pass electrical cables 6 from the arrangement of coils 5.

The modular magnetic axial bearing 1 includes a connector plate 7 electrically connected to and projecting relative to the arrangement of coils 5.

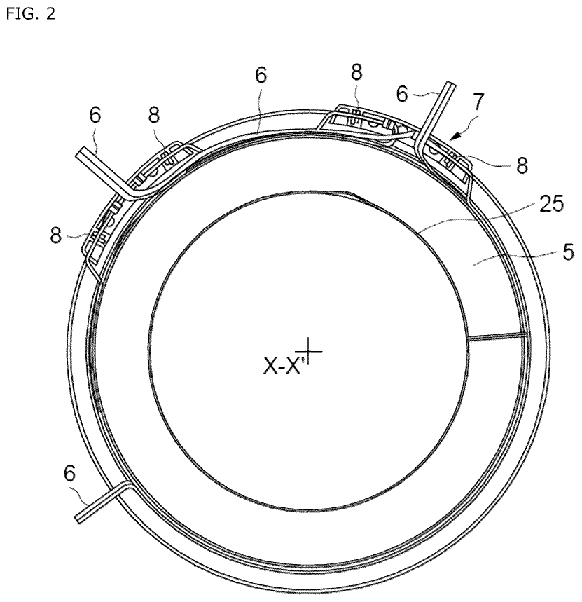

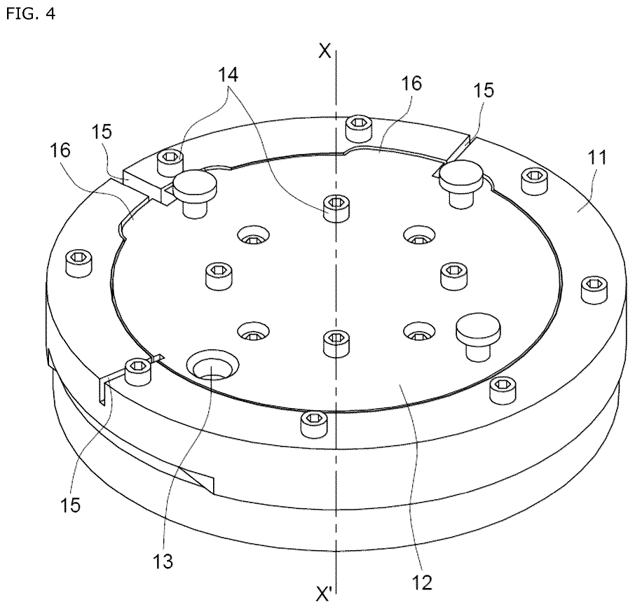

FIG. 4 depicts the FIG. 2 overmoulding mould 11 in a position closed by a disk 12 serving as a cover.

The disk 12 includes specific shapes for closing the overmoulding mould 12 and can notably include a projection 16 housed in a cavity 10, as depicted in FIG. 4, which enables the cavity 10 to serve to immobilise against rotation both the disk 12 and the arrangement of coils 5.

As depicted in FIG. 3, the modular magnetic axial bearing 1 includes two connector plates 7 from which depart the cables 6 that will project from the overmoulded block 18. Alternatively, it is possible to provide a single connector plate 7 or at least three connector plates 7.

Each connector plate 7 is overmoulded in the overmoulded block 18.

The overmoulded block 18 further includes at least one radial protuberance 20, here two protuberances 20.

Thus each connector plate 7 is overmoulded in the overmoulded block 18 and at least partially in one of the radial protuberances 20.

The base 2 includes a hollow in which each radial protuberance 20 is engaged in such a manner as to prevent rotation thereof about the longitudinal axis XX′ of the arrangement of coils 5 relative to said base 2 when the overmoulded block 18 is inserted in the housing 26 in the base 2.

Thanks to the complementary anti-rotation shapes that the radial protuberance 20 and the associated hollow form the overmoulded block 18 is therefore caused to slide in the base 2, the fit in the base 2 being configured to provide small radial and angular clearances allowing only sliding of the overmoulded block 18 along the longitudinal axis XX′.

The overmoulded block 18 is inserted in the base 2 and the angular position of the connector plate 7 adjusted thanks to the radial protuberances 20 facing the hollows of the base, notably with the cables 6 routed to the intended outlet zone.

The modular magnetic axial bearing 1 can further be such that the connector plate 7 includes an insulation displacement contact 8 or a plurality of insulation displacement contacts 8 that makes it possible to facilitate the operation of interconnection of the cables 6 and/or the ends of the winding wires of the coils, enabling a simple, rapid and secure electrical connection that is mechanically protected.

Thus the connections of the winding wires to the insulation displacement contacts 8 provided for this purpose can advantageously be made during the production process.

Each insulation displacement contact 8 is unable to accept a wire with a diameter greater than one millimetre and it is therefore feasible to double the number of coils and therefore also the number of insulation displacement contacts 8, to limit the current density in each coil and the connectors.

Connection includes a step of crimping the cables in the insulation displacement contacts 8 and then immobilising the cables crimped in the insulation displacement contactors 8 by means of retaining parts, for example jumpers, provided for this purpose.

Other components can be added to the arrangement of coils 5, such as a probe, notably a temperature probe.

Once the arrangement of coils 5 has been enclosed in the housing 26 of the bearing support 2 the temperature probe enables the temperature in the bearing 1 to be determined in order to prevent overheating of the bearing 1, all of the energy due to copper losses remaining in the housing after the latter is closed by the cover 3.

If the method relates to the production of a modular magnetic axial bearing 1 including a connector plate 7 connected to the arrangement of coils 5 the overmoulding mould 11 used preferably includes the cavity 10 forming a hollow in which the connector plate 7 is engaged in such a manner as to block rotation of the arrangement of coils 5 relative to said overmoulding mould 11 about the axis XX′ when the arrangement of coils 5 is overmoulded in the overmoulding mould 11 during said production method.

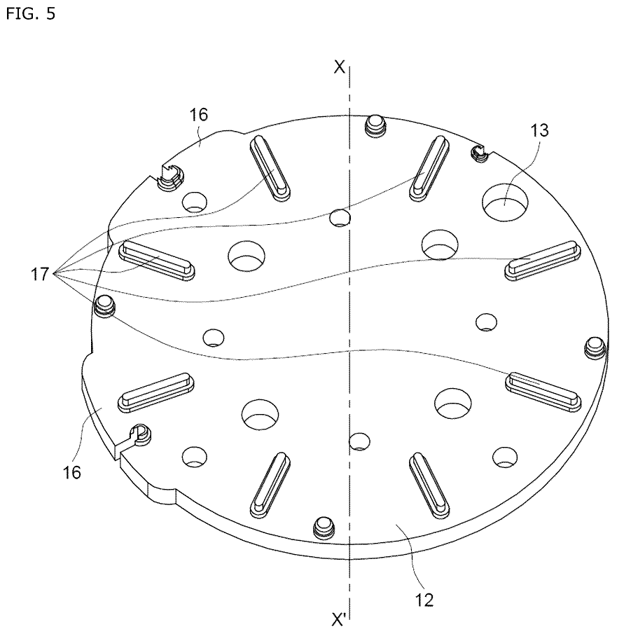

The disk 12, depicted in FIGS. 4 and 5, can include extensions of the third passages 15 also allowing the cable 6 to pass through them during the overmoulding operation.

The disk 12 includes an entry 13 through said disk 12 enabling pouring of an overmoulding material in the liquid state, for example a hot resin, for example epoxy resin, into the overmoulding mould 11 in which the arrangement of coils 5 is located.

The disk 12 can include reliefs 17 making it possible to create grooves 21 in the overmoulded block as depicted in FIG. 6, which grooves absorb thermal expansion stresses in the overmoulded block 18 in use.

Using the overmoulding mould 11 makes it possible to dispense with the overmoulding step executed directly in the base 2 in the conventional methods.

The overmoulding mould 11 includes passages 15 allowing passage of the cables 6 coming from the overmoulded block 18, more specifically the arrangement of coils 5, during the overmoulding operation, to prevent them from being damaged and/or overmoulded, since they are intended to connect the arrangement of coils 5 to an industrial machine through the bearing support 2.

In this method the overmoulding mould 11 is covered by a disk 12 serving as a cover removably fixed to the overmoulding mould 11 by removable closing means 14, such as screws.

Thus the arrangement of coils 5 is removably mounted in the housing 26 while being integrated into the overmoulded block 18 that is itself also removable from the bearing body 2.

The modular magnetic axial bearing 1 can further include an electrically insulative part 25 that is placed in the housing 26 between the base 2 and the arrangement of coils 5 before overmoulding and is embedded in the overmoulded block 18.

This electrically insulative part 25 enables electrical insulation of the overmoulded block 18 directly before placing it in the housing 26 of the base 2.

The electrically insulative part is for example a sheet of insulative paper that is disposed on the inside diameter and the bottom of the housing of the base 2 and has been overmoulded in such a manner as to be integrated into the overmoulded block 18.

The removability of the arrangement of coils 5, more particularly of the overmoulded block 18, from the bearing body 2 makes it possible to withdraw the overmoulded block 18 for possible replacement of the arrangement of coils 5 without having to destroy the overmoulded assembly that usually integrates coils directly overmoulded in a base, that is to say not removable therefrom.

The removability of the arrangement of coils 5, more specifically of the overmoulded block 18, from the bearing body 2 also enables use of a production method enabling non-destructive and therefore particularly advantageous demounting of the modular magnetic axial bearing 1 as described hereinabove in which the arrangement of coils 5 is overmoulded in the overmoulding mould 11 to form an overmoulded block 18 integrating said arrangement of coils 5 and said overmoulded block 18 is placed in the base 2 and the base 2 is removably closed using the cover 3.

This method of producing the modular magnetic axial bearing 1 allows preparation in advance of the whole of the arrangement of coils 5 and overmoulding thereof, which enables an overmoulded block 18 already tested to be obtained ready for use in the production method.

Furthermore, the overmoulded block 18 is modular because it can be mounted on different bearing supports 2 including a blind housing 26 with the same or analogous dimensions.

The advantages of the modular magnetic axial bearing 1 and its production method are therefore economic, logistic and qualitative, the method integrating a pre-assembly step enabling some production in advance to constitute a stock, but also production in a third party place of production of the bearing support 2.

Furthermore, the encapsulation of the arrangement of coils 5 in the overmoulded block 18 having been done already, retaining this block in the base 2 is guaranteed by mechanical immobilisation and no longer by adhesion of the overmoulding resin, also reducing the risk of cracking and loss of material of the modular magnetic axial bearing 1 in use.

Furthermore, over and above the fact that they can be replaced once removably inserted in the bearing support 2, the stored overmoulded blocks 18 have been electrically tested, which renders them more reliable.

The modular magnetic axial bearing 1 includes means 9 for removable closure of the cover 3 on the base 2, such as screws, and an elastic assembly 24 mounted in compression between the cover 3 and the base 2 or the overmoulded block 18 in such a manner as to push said cover 3 along the longitudinal axis XX′ against said removable closure means 9.

The overmoulded block 18 can further include cavities 19 intended to receive some or all of the elastic assembly 24.

The elastic assembly 24 can include a plurality of elastic elements in the cavities 19.

For example, the cavities 19 are disposed in a circle around the longitudinal axis XX′.

The elastic elements 24 advantageously include a material including elastomer or metal.

For example, at least one of the elastic elements 24 has a ball shape, a toroidal shape, an annular shape, a continuous elongate shape open or closed on itself, a spring shape or a corrugated blade shape.

The elastic elements 24 serve to preload the overmoulded block 18, guaranteeing mechanical retention during use of the modular magnetic axial bearing 1 and contact with the metal to perform the exchange of heat necessary for each coil of the arrangement of coils 5.

Using elastic elements, notably of circular shape around the longitudinal axis XX′, in such a manner as to push the cover 3 uniformly relative to the overmoulded block 18 makes it possible to avoid having to perform the overmoulding precisely over a height corresponding to the height from the bottom of the housing 26 to the cover 3, which is advantageous because this height is particularly difficult to obtain in a precise and repeatable manner, given the dimensional margins of overmoulding.

Thanks to the elastic elements 24 positioned in a circular manner, that is to say in a balanced manner, around the longitudinal axis XX′ the overmoulded block 18 is therefore pressed against the bottom of the housing 26 thanks to the distributed thrust of the elastic elements 24 against the cover 3 retained thanks to the removable closure means 9 disposed so that when the cover 3 is added during the method of producing the modular magnetic axial bearing 1 the elastic elements 24 force the overmoulded block against the bottom of the housing 26 in a centred axial position around said longitudinal axis XX′.

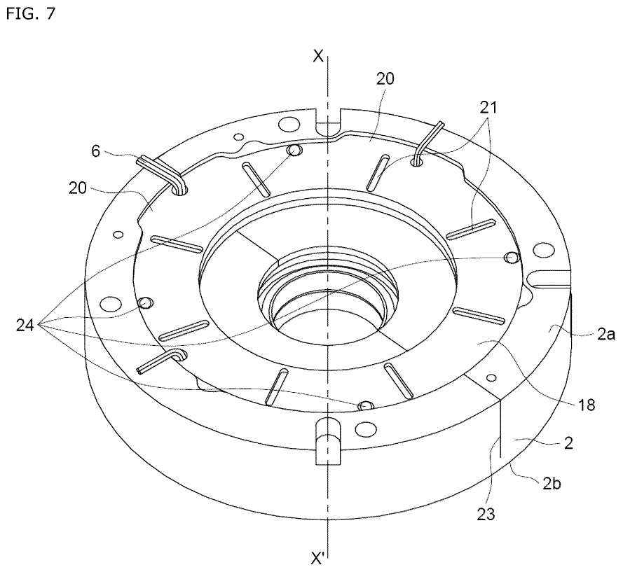

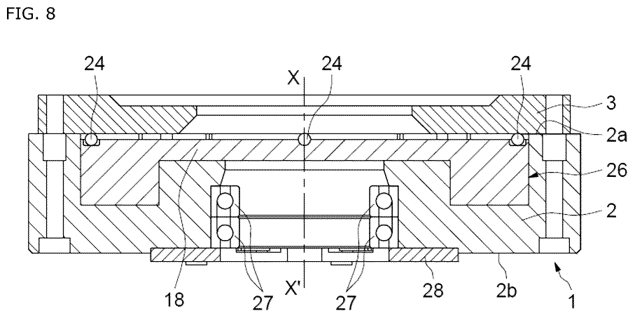

In a first embodiment of the modular magnetic axial bearing 1 depicted in FIGS. 7 and 8 the elastic elements include elastomer and have a ball shape.

The choice of a ball shape facilitates manipulation and notably positioning of the elastic elements 24.

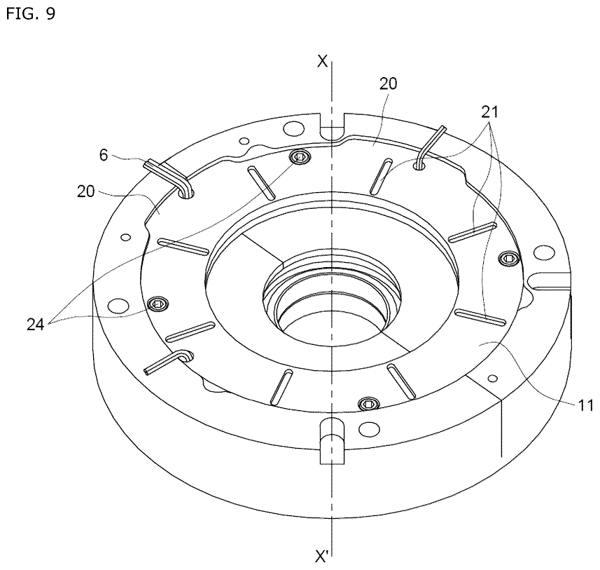

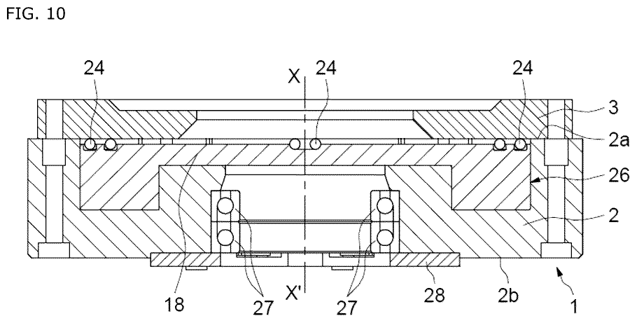

In a second embodiment of the modular magnetic axial bearing 1 depicted in FIGS. 9 and 10 the elastic elements include elastomer and have a toroidal shape, for example a washer shape.

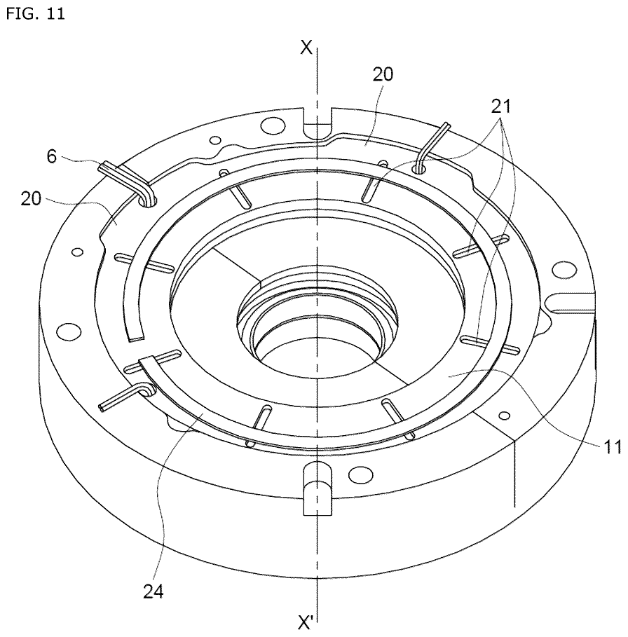

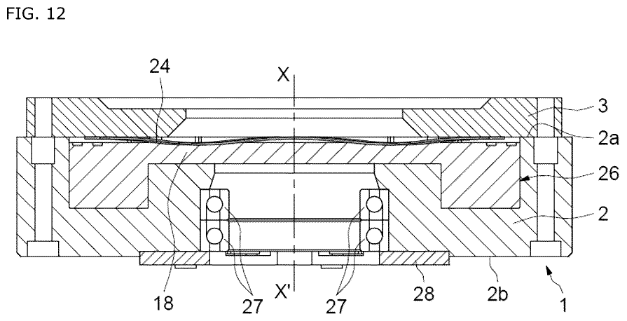

In a third embodiment of the modular magnetic axial bearing 1 depicted in FIGS. 11 and 12 the elastic elements include metal and have a corrugated blade shape disposed around the longitudinal axis XX′.

As depicted in FIGS. 7 to 12 all embodiments of the modular magnetic axial bearing 1 include a slot 23 that provides a mechanical clearance.

The slot 23 cannot be added to the bearing support in the prior art axial bearing module designs in which the overmoulding step is carried out directly in the bearing support since the slot would constitute an area of leakage of the overmoulding material that would rule out carrying out this overmoulding directly.

As depicted in FIG. 8, FIG. 10 and FIG. 12 the modular magnetic axial bearing 1 can include a back-up bearing 27 formed of a plurality of back-up windings and a plate 28 supporting said back-up bearings disposed around the longitudinal axis XX′, said back-up bearings being redundant elements intended to replace other elements of the modular magnetic axial bearing 1 in the event of failure thereof.

What is claimed is:

1. A modular magnetic axial bearing comprising:
a base extending along a longitudinal axis, the base having a blind cavity;
an arrangement of coils;
an annular overmoulded block, the arrangement of coils being embedded inside the overmoulded block, the overmoulded block being removably mounted in said blind cavity; and
a cover removably mounted on the base in such a manner as to enclose said overmoulded block in said blind cavity.

2. The modular magnetic axial bearing according to claim 1, further comprising an electrically insulative part embedded in the overmoulded block.

3. The modular magnetic axial bearing according to claim 1, further comprising:
a removable means for closure of the cover on the base; and
an elastic assembly mounted in compression between the cover and the base or the overmoulded block in such a manner as to push said cover along the longitudinal axis against said removable closure means.

4. The modular magnetic axial bearing according to claim 3, wherein the elastic assembly includes a plurality of elastic elements disposed in a circle around the longitudinal axis.

5. The modular magnetic axial bearing according to claim 4, wherein the elastic elements include a material including elastomer or metal.

6. The modular magnetic axial bearing according to claim 4, wherein at least one of the elastic elements has a ball shape, a toroidal shape, an annular shape, a continuous elongate shape open or closed on itself, a spring shape or a corrugated blade shape.

7. The modular magnetic axial bearing according to claim 1, wherein the overmoulded block includes at least one radial protuberance and the base includes a hollow in which said protuberance is engaged in such a manner as to immobilise the arrangement of coils in rotation about the axis relative to said base.

8. The modular magnetic axial bearing according to claim 7, further comprising a connector plate electrically connected to and forming a projection relative to said arrangement of coils, the connector plate being overmoulded in the overmoulded block and at least partially in the radial protuberance.

9. The modular magnetic axial bearing according to claim 8, wherein the connector plate includes at least one insulation displacement contact.

10. The modular magnetic axial bearing according to claim 2, further comprising:
a removable means for closure of the cover on the base; and
an elastic assembly mounted in compression between the cover and the base or the overmoulded block in such a manner as to push said cover along the longitudinal axis against said removable closure means.

11. The modular magnetic axial bearing according to claim 10, wherein the elastic assembly includes a plurality of elastic elements disposed in a circle around the longitudinal axis.

12. The modular magnetic axial bearing according to claim 11, wherein the elastic elements include a material including elastomer or metal.

13. The modular magnetic axial bearing according to claim 12, wherein at least one of the elastic elements has a ball shape, a toroidal shape, an annular shape, a continuous elongate shape open or closed on itself, a spring shape or a corrugated blade shape.

14. The modular magnetic axial bearing according to claim 13, wherein the overmoulded block includes at least one radial protuberance and the base includes a hollow in which said protuberance is engaged in such a manner as to immobilise the arrangement of coils in rotation about the axis relative to said base.

15. The modular magnetic axial bearing according to claim 14, further comprising a connector plate electrically connected to and forming a projection relative to said arrangement of coils, the connector plate being overmoulded in the overmoulded block and at least partially in the radial protuberance.

16. The modular magnetic axial bearing according to claim 15, wherein the connector plate includes at least one insulation displacement contact.

17. A method of producing a modular magnetic axial bearing according to claim 16, the method comprising:
overmoulding the arrangement of coils in an overmoulding mould to form an overmoulded block integrating said arrangement of coils;
placing the overmoulded block in the blind cavity of the base; and
enclosing the overmoulded block in the base by removably closing the base with the cover.

18. A method of producing a modular magnetic axial bearing according to claim 1, the method comprising:
overmoulding the arrangement of coils in an overmoulding mould to form an overmoulded block integrating said arrangement of coils;
placing the overmoulded block in the blind cavity of the base; and
enclosing the overmoulded block in the base by removably closing the base with the cover.
